(19) United States
(12) Patent Application Publication
(10) Pub. No.: US 2017/0273143 A1
(43) Pub. Date: Sep. 21, 2017

(54) TEMPERED PORTABLE WASH UNIT

(71) Applicant: Haws Corporation, Sparks, NV (US)

(72) Inventors: Stephen Lee Stanley, Sun Valley, NV (US); Michael Joyer, Sparks, NV (US)

(21) Appl. No.: 15/461,346

(22) Filed: Mar. 16, 2017

Related U.S. Application Data
(60) Provisional application No. 62/309,255, filed on Mar. 16, 2016.

(51) Int. Cl. H05B 1/02; A61H 35/02; B05B 9/00

(52) U.S. Cl. CPC H05B 1/0244; B05B 9/002; A61H 35/02; H05B 2203/021

(57) ABSTRACT

The tempered portable wash unit generally includes a container having an interior for selectively receiving and retaining a select quantity of fluid. A dispenser may be coupled with the container and be in fluid communication with the fluid retaining interior, the dispenser being actuable between a first closed position restricting outflow of fluid from the container and a second open position permitting dispensing fluid from the container. A heat trace cable may couple with the container and be positioned therewith for generating variable heat along its length thereof in response to changes in localized temperatures to generally maintain the temperature of the fluid within the container within a desired threshold temperature comprising a range of 60° F. to 100° F. in ambient atmospheric temperatures as low as −30° Fahrenheit (“F”) and in compliance with an ANSI Class 1 Div. 1 classification.

### BACKGROUND OF THE INVENTION

The present invention generally relates to a tempered portable wash unit. More specifically, the present invention relates to a tempered portable eyewash unit heated by an insulated heat trace cable to allow for installation in sub-zero and explosive environments.

Portable eyewash units are generally known in the art and are ideal for use in remote locations where a mains water supply may not be readily available for use with a traditional emergency eyewash unit. In this respect, known portable eyewash units typically include relatively large water retaining chambers or tanks that include a water dispensing assembly pivotally coupled thereto. Water dispenses from the water retaining tank or chamber when the water dispensing assembly is pivoted from an upright position adjacent the chamber or tank to an outwardly projecting position whereby gravity causes a continuous supply of clean water to flow out from the chamber or tank for a desired length of time. For example, Haws Corporation of 1455 Kleppe Lane, Sparks, Nev. 89431-6467 manufactures and sells a portable gravity fed eyewash unit under Model 7501, which can provide a continuous flow of water for 15 minutes at a rate of 0.4 gallons per minute (“gpm”). Such a portable eyewash unit may be made from an FDA approved high-density green polyethylene tank that can be activated by pulling down on a yellow activation arm, which causes deployment of a pivoting water dispensing assembly from an upright position adjacent the tank to an outwardly projecting dispensing position. Such a portable eyewash unit may include a wide-fill opening with threaded cap to permit inspection, cleaning, and filling. In this respect, such a portable eyewash unit may be easily relocated by emptying the relatively lightweight plastic tank, transporting the empty tank to the desired location, and securing the tank as needed. While portable, one drawback of such an eyewash unit is that it is typically not usable in cold weather environments.

In cold weather environments, the water in the portable eyewash unit can fall to an undesirably low level or may even freeze if the surrounding temperatures are too low. Cold water conditions may adversely affect the performance of the portable eyewash unit because the water needed and used to wash away contaminants during an emergency may be too cold for the user. Furthermore, if the water freezes, the eyewash unit will obviously not dispense any water whatsoever in an emergency situation. Accordingly, there are several known prior art devices that offer freeze-resistant portable eyewash units, but none can function at −30° Fahrenheit (“F”), none can adequately temper the water as a result of using silicon heating pads or immersion heaters, and none are compliant with the Class 1 Div. 1 classification.

In one example, Bradley Corporation of W142 N9101 Fountain Boulevard, Menomonee Falls, Wis. 53051 manufactures and sells an on-site gravity-fed eyewash unit under Model S19-921H. The Bradley eyewash unit includes a transparent tank assembly having a waterproof insulated heater jacket made from a high-visibility material (e.g., yellow) of 200 Denier foam-backed nylon with a clear vinyl pocket having a cord that couples to an electrical outlet. The insulated jacket is of a size and shape to form fit around the outside of the water retaining tank. The insulated heater jacket includes a plurality of heating pads that thermostatically control the water temperature in weather conditions down to −10° F. The problem with the heating pads is that the energy generated thereby is inefficiently transferred to the water inside the tank, hence Bradley Model S19-921H is only rated for use in temperatures down to approximately −10° F.

Another example is the AquaGuard 16 Gallon Gravity Operated Portable Eye Wash with Heather Orange Insulation jacket (Model G1540HTR) manufactured and sold by Guardian Equipment of 1140 N. North Branch St., Chicago, Ill. 60642. The AquaGuard is a self-contained heated and insulated gravity flow eyewash unit that uses gravity to deliver water through dual spray heads, and can be used in low or freezing temperatures. The portable eyewash unit is freeze resistant through use of a plurality of heating pads made of silicon rubber that attach to the unit sidewalls with pressure sensitive adhesive. A remotely viewable electronic temperature controller may provide a visual indication that the heating pads are activated. Although, while somewhat more efficient, the silicon rubber heating pads are only rated to operate at temperatures down to −20° F. Again, the problem with the silicon rubber heating pads is that the energy generated thereby is inefficiently transferred to the water inside the tank, hence Guardian Equipment Model G1540HTR is not rated to operate below −20° F.

In another example, Encon Safety Products of 6825 W Sam Houston Pkwy. N, Houston, Tex. 77041 manufactures and sells a Heated Gravity Fed Portable Eyewash under Model No. 01104070 that includes a portable self-contained heated gravity fed eyewash unit with an insulated jacket used in areas where plumbed potable water is not available. The heater is designed to maintain the water temperature in the tank to near 85° F. to help prevent cold water shock to the user. The eyewash unit uses a float sensor to determine whether the water level is at a threshold level to activate the heater, and to prevent super heating the water therein if the water level is too low. Furthermore, the eyewash unit also includes a control thermostat that senses the water temperature to help maintain a constant temperature between threshold values. Although, similar to Bradley Corp. Model S19-921H and the Guardian Equipment Model G1540HTR, Encon Model No. 01104070 uses an insulated jacket rated only down to −20° F., which may be too high of a temperature rating for extremely cold temperature conditions.

Other prior art portable eyewash units known in the art with freeze protection use an insulation blanket and an electric immersion heater. Although, the immersion heater does not produce evenly distributed heat, requires undesirably high power consumption, and does not produce tempered water. These drawbacks are similar to the aforementioned freeze-resistant portable eyewash units that produce localized heating using silicon heating pads or the like, especially with respect to the inability to produce tempered water. None of the aforementioned products are rated for explosion proof environments, but only up to Class 1 Div. 2.

There exists, therefore, a significant need for a tempered portable eyewash unit that includes an insulated heat trace cable to allow for installation in sub-zero and explosive environments and rated to temperatures at least as low as −30° F. and compliant with the Class 1 Div. 2 classification. The present invention fulfills these needs and provides further related advantages.

### SUMMARY OF THE INVENTION

One embodiment of a tempered portable wash unit as disclosed herein may include a container having an interior for selectively receiving and retaining a select quantity of fluid that may be used, e.g., as an emergency eyewash unit. In this respect, a dispenser may couple with the container and be in fluid communication with the fluid retaining interior. The dispenser may be actuable between a first closed position restricting outflow of fluid from the container during non-use and a second open position permitting dispensing fluid from the container when in use, such as in an emergency. The tempered portable wash unit may further include a heat trace cable coupled with the container and positioned therewith for generating variable heat along its length thereof in response to changes in localized temperatures to generally maintain the temperature of the fluid within the container within a desired threshold temperature.

More specifically, the heat trace cable may be generally equidistantly disposed about the container and operable to maintain fluid therein at a desired threshold temperature between 60° F. to 100° F. in an ambient atmospheric temperature as low as −30° Fahrenheit (“F”). To this end, the container, the dispenser, and the heat trace cable may be compliant with an ANSI Class 1 Div. 1 classification and rated for deployment in sub-zero and explosive environments. The heat trace cable may include a self-regulating temperature material that decreases electrical resistance with decreased temperature along certain sections of its length thereof, thereby variably increasing heat along those certain sections, while simultaneously increasing electrical resistance with increased temperature along other certain sections of its length thereof, thereby variably decreasing heat along the other certain sections. In other words, the heat trace cable is able to regulate and vary the heat generated at various sections along its length. This allows the heat trace cable to more specifically apply localized heat to cooler areas of the container, while simultaneously decreasing localized heat generation to hotter areas of the container. This facilitates automatic and even tempered heating and/or cooling of fluid within the container.

Additionally in this respect, the heat trace cable may operate in association with a current restrictor inline with the heat trace cable and responsive to temperature changes. Here, the current restrictor may be able to increase current along the heat trace cable in response to decreased temperatures and decrease current along the heat trace cable in response to increased temperatures. Additionally, the heat trace cable may include a semi-conductive polymer that restricts heat generation along its length to temperatures below a pre-determined threshold temperature, to prevent overheating. An insulative covering that includes a foil tape may be at least partially disposed over at least a portion of the heat trace cable to generally deflect heat from the heat trace cable toward the interior of the container. Here, the heat trace cable may include a rectangular cross-section and be flush mounted to an exterior of the container. An insulation jacket surrounding the container may sandwich the heat trace cable between the insulation jacket and the exterior of the container.

The tempered portable wash unit may also include a temperature probe positioned within the interior of the container for taking periodic or real-time temperature readings of fluid therein and/or an over-temp thermostat for monitoring an ambient air temperature. A central controller may operate the heat trace cable, the temperature probe, and/or the over-temp thermostat. In this respect, the controller may activate and/or deactivate the heat trace cable in response to temperature readings from the temperature probe. The controller may also turn “off” or otherwise restrict power to the heat trace cable when the ambient air temperature exceeds a predetermined temperature identified by the over-temp thermostat.

In another embodiment as disclosed herein, a tempered portable wash unit retrofit system may include a generally flexible jacket having a size and shape for selectively surrounding a container having a chamber for selectively receiving and retaining a select quantity of fluid. A heat trace cable may generally line an interior of the flexible jacket so that the heat trace cable is disposed in adjacent relation to an exterior of the container when the flexible jacket is wrapped about the container. Here, the heat trace cable may generate variable heat along its length thereof in response to changes in localized temperatures to generally maintain the temperature of the fluid within the container within a desired threshold temperature between 60° F. and 100° F. The flexible jacket may include a foil liner for deflecting heat generated by the heat trace cable toward the container. Additionally, the flexible jacket may include an insulation layer for more efficiently controlling the loss of heat generated by the heat trace cable, for heating liquid within the container.

More specifically, the heat trace cable may be disposed at approximate equidistant intervals along the interior of the flexible jacket and operable to maintain fluid within the container at the desired threshold temperature in an ambient atmospheric temperature as low as −30° Fahrenheit (“F”). Here, generally parallel sections of the heat trace cable may be offset by one another by approximately 1-3 inches and the heat trace cable may be offset from an outer and an inner periphery of the flexible jacket by approximately 1-3 inches. The heat trace cable may be rectangular in cross-section, positioned flush against the interior of the flexible jacket, and may include a self-regulating temperature material that decreases electrical resistance with decreased temperature along a first length thereof, thereby variably increasing heat along the first length, while simultaneously increasing electrical resistance with increased temperature along a second length thereof, thereby variably decreasing heat along the second length.

In another aspect of this embodiment, the flexible jacket may include a dispenser pocket configured to generally align with a dispenser of the container. The dispenser pocket may be actuable between a first closed position positioning the dispenser in a flow restricting position, and a second open position moving the dispenser to a second flow permitting position. The dispenser pocket may do so by way of attaching one or more straps to the container dispenser. The flexible jacket, the container, the dispenser, and the heat trace cable may be rated for deployment in sub-zero and explosive environments and may be compliant with a Class 1 Div. 1 classification.

In another alternative embodiment, the tempered portable wash unit as disclosed herein may include a container having an interior for selectively receiving and retaining a select quantity of fluid and a dispenser coupled with the container and in fluid communication with the fluid retaining interior, the dispenser being actuable between a first closed position restricting outflow of fluid from the container and a second open position permitting dispensing fluid from the container. Moreover, a heat trace cable may couple with the container and be positioned therewith for generating variable heat along its length thereof in response to changes in localized temperatures to generally maintain the temperature of the fluid within the container within a desired threshold temperature including a range of 60° F. to 100° F. when the tempered portable wash unit is in an environment where the ambient atmospheric temperatures are as low as −30° Fahrenheit (“F”), all in compliance with an ANSI Class 1 Div. 1 classification.

Additionally, the tempered portable wash unit may include a temperature probe positioned within the interior of the container for taking periodic or real-time fluid temperature readings. The heat trace cable may also include a current restrictor that includes a semi-conductive polymer that restricts heat generation to below a pre-determined threshold temperature. Additionally, the tempered portable wash unit may include a controller for activating and/or deactivating the heat trace cable in response to fluid temperature readings from the temperature probe or ambient air temperature readings from the over-temp thermostat. The controller may be able to restrict power to the heat trace cable (or otherwise turn the heat trace cable “on” or “off”) when the fluid temperature or the ambient air temperatures exceed or fall below certain predetermined threshold temperatures. Moreover, an insulative covering that includes a foil tape may be at least partially disposed over at least a portion of the heat trace cable to generally deflect heat from the heat trace cable toward the interior of the container.

In an alternative aspect of these embodiments, the heat trace cable may include a rectangular cross-section and may be flush mounted to an exterior of the container and sandwiched in between the exterior of the container and an insulation jacket surrounding the container. Here, the container, the dispenser, the heat trace cable, and the jacket may be rated for deployment in sub-zero and explosive environments. Lastly, the heat trace cable may include a self-regulating temperature material generally equidistantly disposed about the container. The self-regulating temperature material may decrease electrical resistance with decreased temperature along a first length thereof, thereby variably increasing heat along the first length, while simultaneously increasing electrical resistance with increased temperature along a second length thereof, thereby variably decreasing heat along the second length.

Other features and advantages of the present invention will become apparent from the following more detailed description, when taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a perspective view of one embodiment of a tempered portable eyewash unit having a heat trace cable attached thereto, as disclosed herein;

FIG. 2 is another perspective view of the tempered portable eyewash unit of FIG. 1, more specifically illustrating the heat trace cable taped to a left side of the unit;

FIG. 3 is another perspective view of the tempered portable eyewash unit of FIGS. 1-2, more specifically illustrating the heat trace cable attached to a right side of the unit;

FIG. 4 is a rear elevation view of the tempered portable eyewash unit of FIGS. 1-3, more specifically illustrating the heat trace cable attached around a backside of the unit;

FIG. 5 is an interior view of an insulation jacket lined with a heat trace cable for wrapping a portable tank;

FIG. 6 is a perspective view illustrating the portable tank placed on the outstretched insulation jacket of FIG. 5;

FIG. 7 is a perspective view of the insulation jacket wrapped around the portable tank, thereby forming an alternative tempered portable eyewash unit;

FIG. 8 is an enlarged front perspective view taken about the circle 8 in FIG. 7, more specifically illustrating an eyewash head in a partially open position as an activation handle of the insulation jacket is pulled outwardly;

FIG. 9 is an enlarged front perspective view similar to FIG. 8, further illustrating the eyewash head assembly pivoting to a fully open and operational position;

FIG. 10 is a perspective view of the alternative tempered portable eyewash unit of FIGS. 7-9 in the fully open and operational position; and

FIG. 11 is an enlarged front perspective view taken about the circle 11 in FIG. 10, further illustrating the eyewash head assembly in the fully open and operational position.

### DETAILED DESCRIPTION OF THE PREFERRED EMBODIMENTS

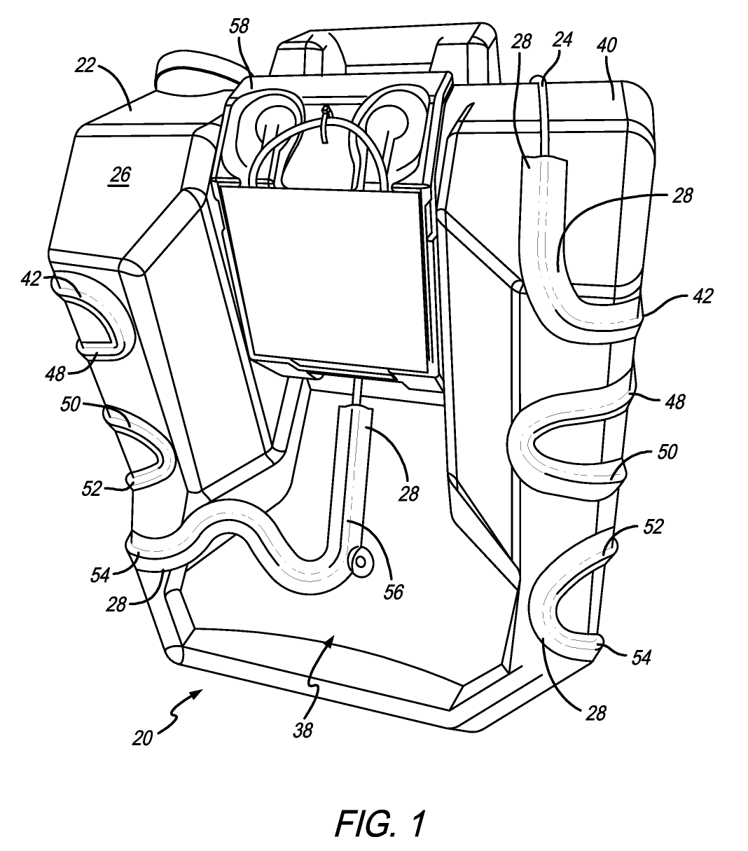

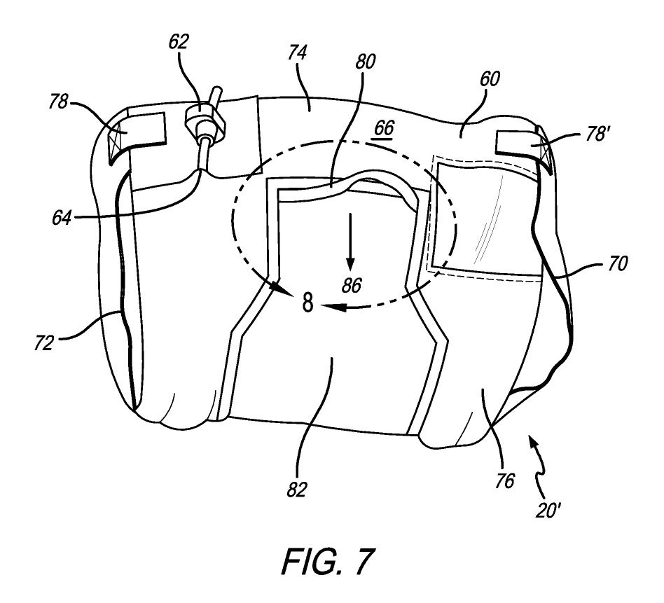

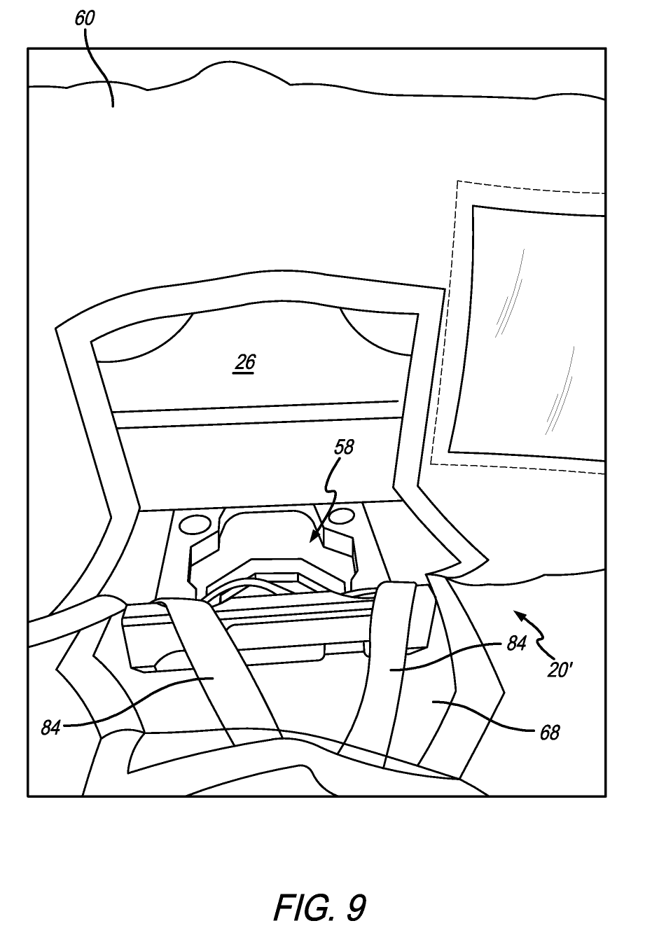

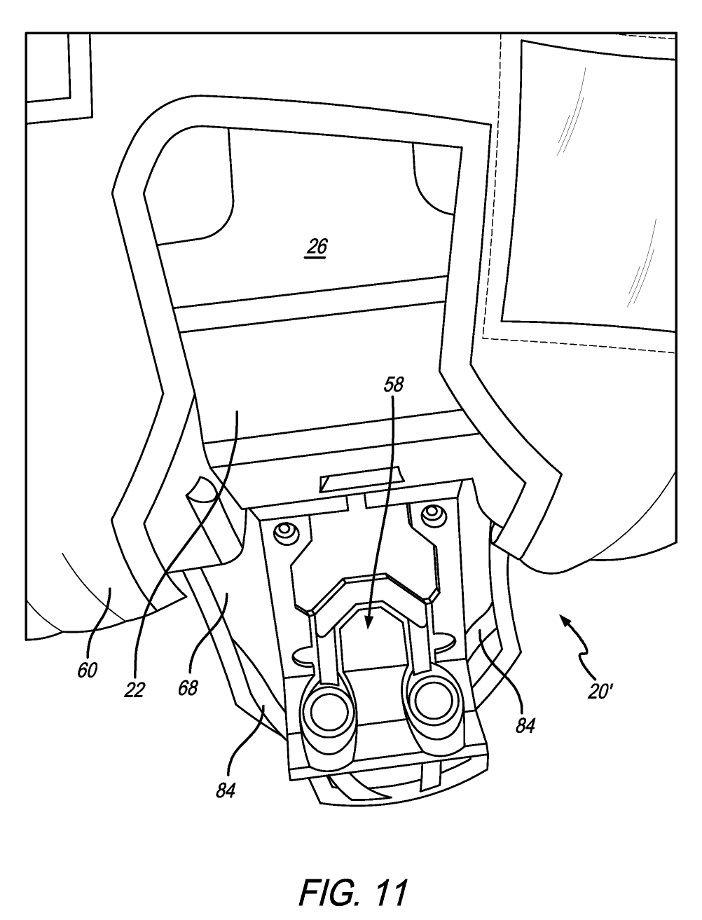

As shown in the exemplary drawings for purposes of illustration, embodiments for a tempered portable eyewash unit as disclosed herein are generally referred to by reference numeral 20 in FIGS. 1-4 and with respect to reference numeral 20′ in FIGS. 7-11. The tempered portable eyewash units 20, 20′ disclosed herein are designed to prevent a portable tank 22 from freezing in cold temperatures up to at least −30° Fahrenheit (“F”). Additionally, the tempered eyewash unit 20 is capable of tempering water in the portable tank 22 between 60° F. and 100° F., in accordance with the requirements set forth by the American National Standards Institute (“ANSI”). Additionally, the tempered portable eyewash units 20, 20′ use explosion-proof heating elements so the units 20, 20′ comply with Class 1 Div. 1 classification and can be installed in classified or explosive environments. As a result, the tempered portable eyewash units 20, 20′ have a lower component cost, have higher power efficiency, and are easier to install and maintain, at least relative to the prior art mentioned above.

More specifically as shown in FIGS. 1-4, the portable tank 22 includes an explosion-rated heat trace cable 24 wrapped uniformly around a outer surface 26 of the portable tank 22 to provide even heat distribution to the water inside and to keep the water in the portable tank 22 from freezing. In one embodiment, the heat trace cable 24 may be able to self-regulate temperature so it cannot overheat. Here, the heat trace cable 24 may be configured to include a resistance that varies with temperature, i.e., the heat trace cable 24 provides relatively low resistance for temperatures below a threshold temperature set point and relatively high resistance for temperatures above the threshold temperature set point. In this respect, when the heat trace cable 24 reaches the threshold temperature set point, the resistance of the heat trace cable 24 may increase, such that the heat trace cable 24 produces less or no more heat. The heat trace cable 24 may also be able to provide higher heat in some areas and lower heat in others, to further ensure tempering of the water inside the portable tank 22. As a result, the heat trace cable 24 can provide or supply heat only where needed along the length of the cable 24 through select current restriction; unlike the prior art insulated heater jackets and/or silicon rubber heating pads. The maximum temperature of the heat trace cable 24 may be based on the type of semi-conductive polymer inside the cable 24. Accordingly, such a self-regulating cable may have a specific maximum exposure temperature based on the type of polymer used to make the heating core.

Alternatively or in addition to, the tempered portable eyewash units 20, 20′ may include a temperature probe disposed within the portable tank 22 that takes periodic or real-time temperature readings of the water inside the portable tank 22 to monitor water temperature and control power to the heat trace cable 24 to maintain ANSI tempered water conditions. Here, the temperature probe could activate and/or deactivate power to the heat trace cable 24, depending on the temperature readings of the water within the portable tank 22. For example, the temperature probe may activate power when temperature readings fall 3-5° F. below the desired operating or set point temperature. The temperature probe may then deactivate power to the heat trace cable 24 when the temperature rises beyond that desired operating or set point temperature (e.g., 3-5° F.). Such a temperature probe could be used alone or in combination with a self-regulating cable, as described above, to prevent scalding water if the ambient temperature becomes too high.

Another safety mechanism for the tempered portable eyewash units 20, 20′ might be integration of a secondary “over-temp” thermostat that monitors the ambient air temperature and is designed to prevent scalding water if the ambient temperatures become too high. Here, power to the heat trace cable 24 may be shut off when the air temperature is too high. The temperature probe and/or the secondary “over-temp” thermostat may be monitored and regulated by a controller (not shown), which may also turn the tempered eyewash unit 20, 20′ “on” and/or “off”, and may also regulate the amount of energy delivered to the heat trace cable 24 in real-time.

In one embodiment, the tempered portable eyewash units 20, 20′, including the heat trace cable 24, are rated Class 1 Division 1 classification for installation in the most extreme environments. More specifically, the principles of a Class 1 environment include explosive mixtures that can penetrate electrical equipment and be ignited. Measures are taken to ensure that the explosion cannot spread to the surrounding atmosphere—this can include an explosion-proof enclosure, dust ignition-proof enclosure, and/or conduit and cable seals. Contrast Class 1 with Classes 2 and 3, where the equipment need only be provided with an enclosure that prevents the ingress of a potentially explosive mixture and/or contact with sources of ignition arising from the functioning of the equipment (Class 2); or wherein potentially explosive mixtures can penetrate the enclosure but must not be ignited—sparks and raised temperatures must only occur within certain limits (Class 3). The division defines the likelihood that the hazardous material be present in a flammable concentrate. Specifically, Division 1 encompasses a condition in which ignitable concentrations of hazards exist under normal operational conditions and/or where the hazard is caused by frequent maintenance or repair work or frequent equipment failure. Contrast this with Division 2, in which ignitable concentrations of hazards are handled, processed, or used, but which are normally in closed containers or closed systems from which they can only escape through accidental rupture or breakdown of such containers or systems. The benefits of the Class 1 Div. 1 tempered portable eyewash units 20, 20′ are immense, and obviously cannot be met by the aforementioned prior art devices, which are currently rated only at Class 1 Div. 2.

As shown in FIGS. 1-4, the heat trace cable 24 is coupled directly to the outer surface 26 of the portable tank 22 by way of an overlaying insulative covering 28 (e.g., foil tape or the like). This eliminates the need to drill holes in the outer surface 26 of the portable tank 22, which could be potential leaking points. Alternatively, mechanical fasteners could be used in combination with or instead of the insulative covering 28, to secure the heat trace cable 24 in close proximity, and preferably flush with, the outer surface 26 of the portable tank 22. In this respect, the closer the heat trace cable 24 can be mounted to the water inside the portable tank 22, the more efficient the heat transfer. Moreover, such direct attachment of the heat trace cable 24 to the outer surface 26 of the portable tank 22 could occur at the factory as part of a combination product, or as a custom retrofit option for existing portable tanks 22. The insulative covering 28 may be particularly efficient as its reflective properties can direct heat from the heat trace cable 24 into the interior of the portable tank 22.

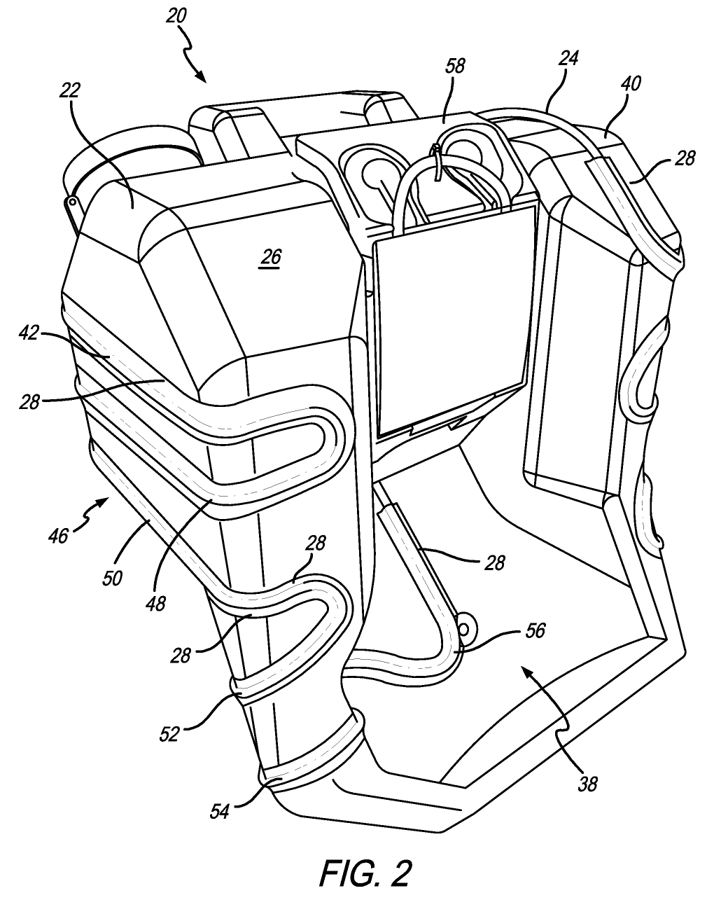

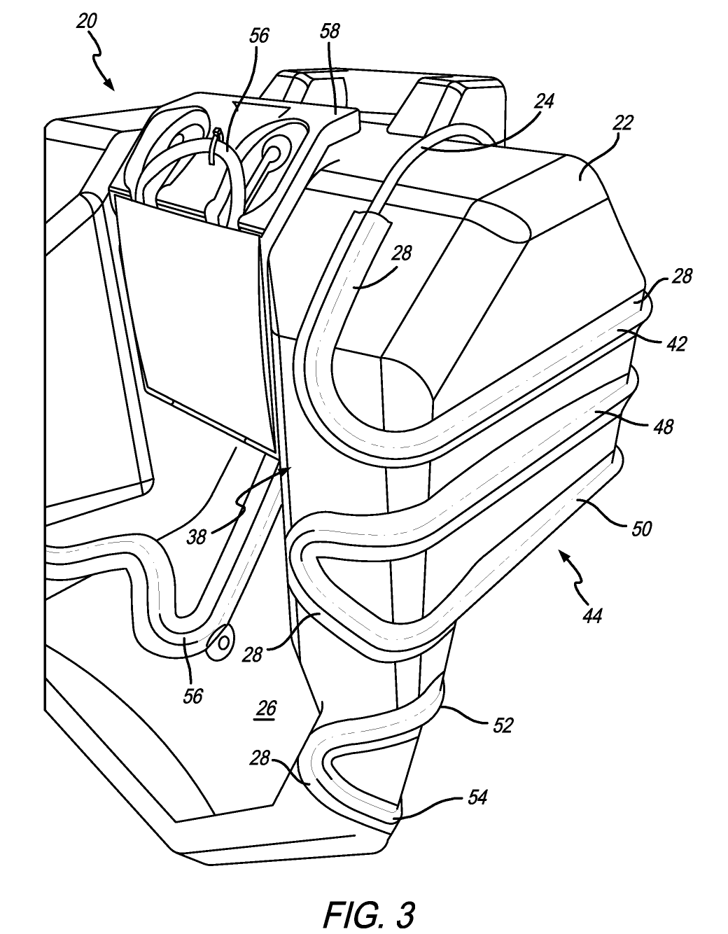

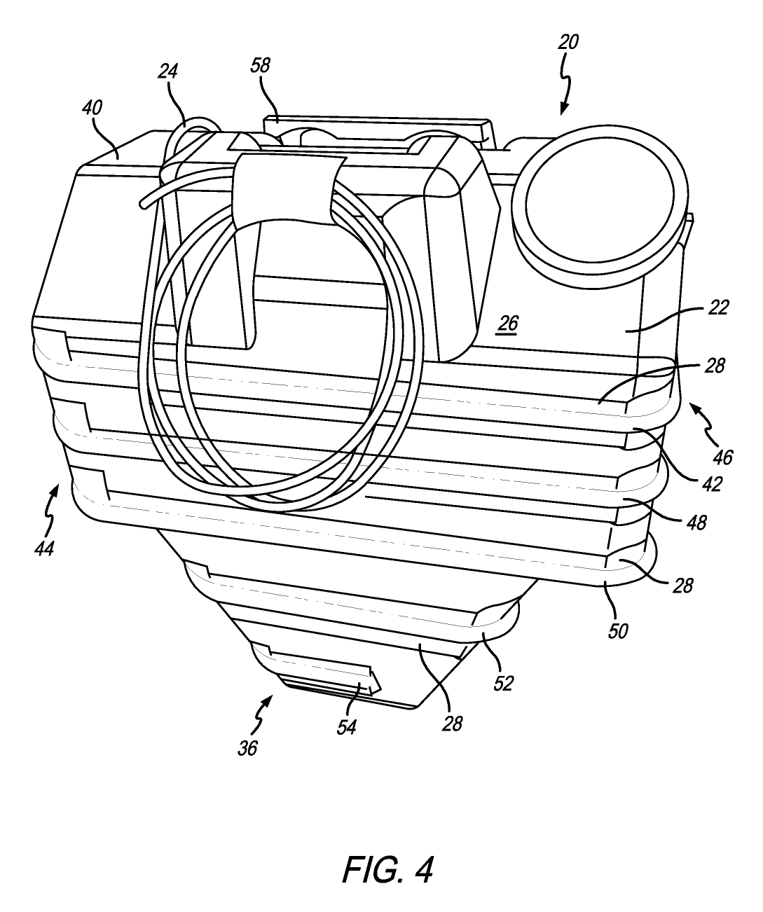

The heat trace cable 24 may originate from a backside 36 of the portable tank 22, travel over the top, and then vertically downwardly approximately a quarter of the way down a front side 38 of the portable tank 22 before transitioning or switching back into a first horizontal section 42. The first horizontal section 42 wraps around a right side 44 of the portable tank 22 to the backside 36 thereof, as shown generally between FIGS. 3 and 4. The first horizontal section 42 travels the horizontal width of the backside 36 as shown in FIG. 4, and then wraps around a left side 46 of the portable tank 22, travels the horizontal width thereof, then wraps around again to the front side 38 where the first horizontal section switches back to a second horizontal section 48. The second horizontal section 48 then wraps around to the left side 46, travels the width thereof, wraps around to the backside 36, travels the width thereof, wraps around to the right side 44, travels the width thereof, and finally wraps around to the front side 38 where the second horizontal section 48 switches back to a third horizontal section 50 (FIGS. 1 and 3). The third horizontal section 50 wraps around the outer surface 26 of the portable container 22 similar to the first horizontal section 42 and, as best shown in FIG. 2, switches back into a fourth horizontal section 52. The fourth horizontal section 52 then wraps around the outer surface 26 of the portable container 22 similar to the second horizontal section 48 and, as best shown in FIG. 3, switches back into a fifth horizontal section 52. The fifth horizontal section 52 wraps around the portable tank 22 similar as the first horizontal section 42 and the third horizontal section 50, but transitions into a lead section 56 that travels up underneath and in and around a pivoting eyewash head assembly 58, including adjacent to a dispense conduit therein. As such, the heat trace cable 24 is shown coupled to the outer surface 26 in a zig-zag pattern at alternating heights. The heat trace cable 24 may be evenly disposed about the outer surface 26 so as to provide tempered heating of the water inside, regardless of the configuration.

In one embodiment, the heat trace cable 24 may include an outer sheath that is substantially rectangular to increase the surface area contact between the heat trace cable 24 and the outer surface 26 of the portable tank 22. In this embodiment, such a heat trace cable 24 may more efficiently transfer heat energy to the water in the interior of the portable tank 22 relative to a circular heat trace cable. Moreover, the insulative covering 28 may deflect the heat energy inwardly toward the water in the portable tank 22, to increase the efficiency thereof, which can be particularly desirable in extremely told temperatures.

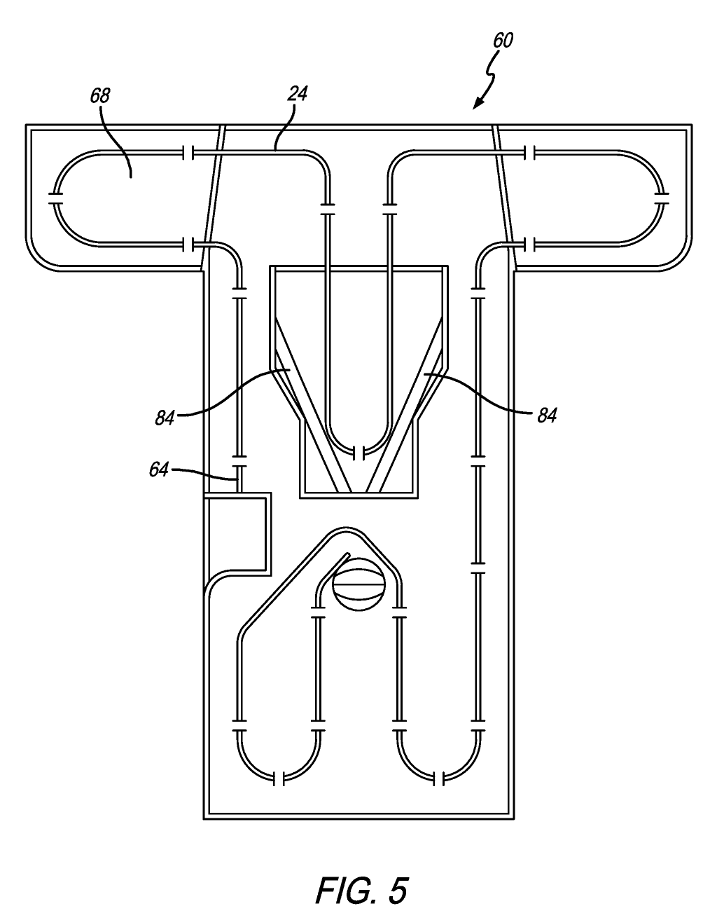

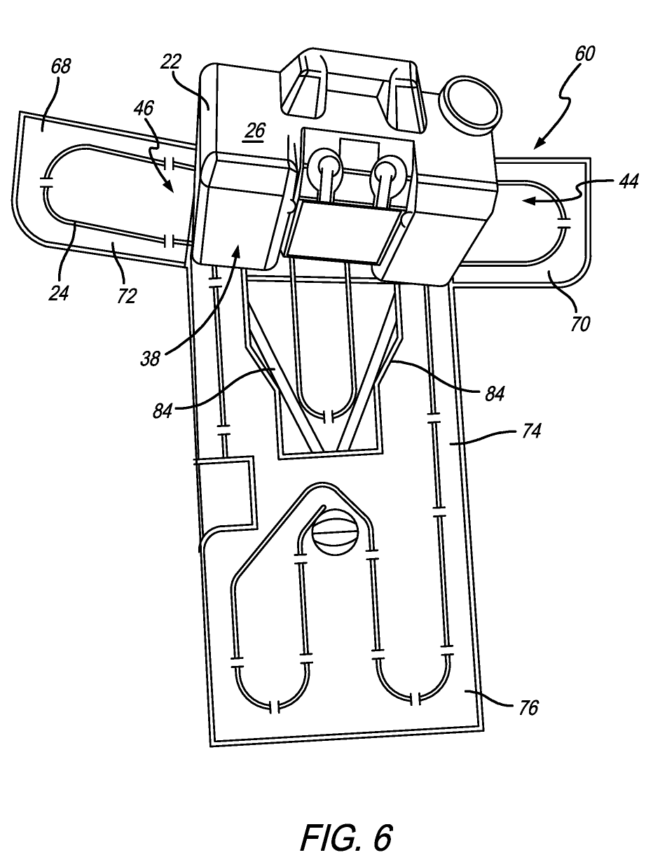

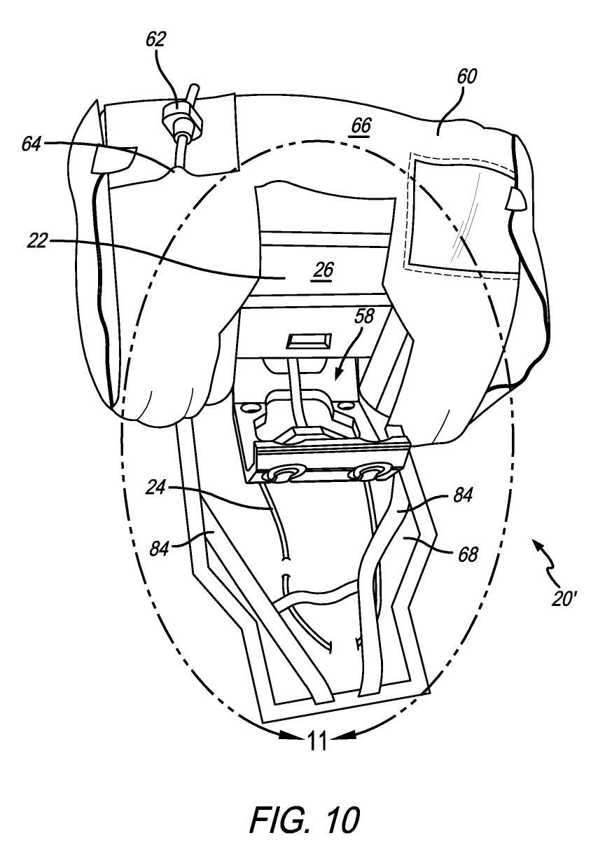

In another aspect, the heat trace cable 24 may be lined inside an insulation jacket 60, as shown in FIGS. 5 and 6, and then combined with the portable tank 22 to form the tempered portable eyewash unit 20′, as shown, for example, in FIGS. 7-11. The insulation jacket 60 is designed as a self-contained retrofit for installation on existing portable tanks in the field without any modifications thereto. In this respect, a power plug 62 (FIGS. 7 and 10) may be at one end of the heat trace cable 24 threaded through an aperture 64 in an outer surface 66 of the insulation jacket 60. In FIG. 5, the heat trace cable 24 is illustrated entering the interior of the insulation jacket 60 through the aperture 64, and then generally following or lining the exterior periphery of the insulation jacket 60. The heat trace cable 24 may line the insulation jacket 60 as shown in FIGS. 5 and 6 (i.e., generally offset approximately 1-3 inches from the outer periphery, and similarly disposed internally at approximately 1-3 inch offsets), or the heat trace cable 24 may line the insulation jacket 60 in other configurations (e.g., zig-zag, or other patterns). In this respect, the heat trace cable 24 should preferably relatively evenly line the insulation jacket 60 to provide evenly distributed energy at the time of activation, to ensure consistent heating of the water inside the portable tank 22 in accordance with the embodiments disclosed herein.

The insulation jacket 60 may also include a foil liner 68 that covers the entire or substantially the entire surface area of the insulation jacket 60 to reflect heat back to the outer surface 26 of the portable tank 22 and create a warm air barrier between the outer surface 26 and the insulation jacket 60. Although, while the foil liner 68 may cover less than the entire or substantially the entire surface area of the insulation jacket 60, such an insulation jacket may not be as energy efficient. To this end, configuring the insulation jacket 60 to direct or reflect heat generated by the heat trace cable 24 toward the outer surface 26 of the portable tank 22 may better ensure consistent and efficient heating of the water inside. In this respect, the insulation jacket 60 may further include an insulation layer (not numbered) that prevents outward heat loss.

The portable tank 22 may be selectively wrapped by the insulation jacket 60 by first placing the portable tank 22 on a portion of the insulation jacket 60 as shown in FIG. 6. In this respect, the insulation jacket 60 may be combined with existing or known portable tanks that include no heating mechanism, to form the tempered portable eyewash unit 20′ disclosed herein. After placing the portable tank 22 on the insulation jacket 60 as shown in FIG. 6, each of a right flap 70 and a left flap 72 may be folded up at an approximately 90 degree angle and adjacent the right side 44 and the left side 46 of the portable tank 22. Similarly, a mid panel section 74 and a top panel section 76 respectively wrap around the front side 38 and the backside 36 to fully encase the portable container 22 therein. The insulation jacket 60 is shown in FIG. 7 being held together by a pair of tape strips 78, 78′; although each of the right flap 70 and the left flap 72 may couple to the mid panel section 74 and the top panel section 76 by a zipper or another mechanical engagement mechanism of the like.

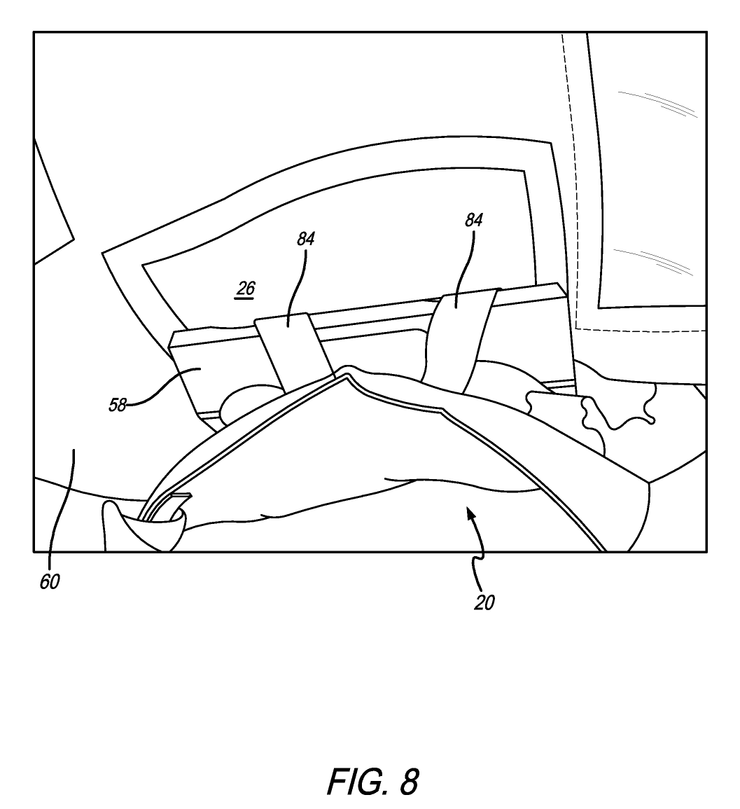

Once wrapped, as shown in FIG. 7, the portable tank 22 can be activated by pulling down on an activation handle 80 coupled to an activation tab 82 that can selectively release from the top panel section 76. For example, the activation tab 82 may couple to the top panel section 76 by hook and loop fasteners or the like. Pulling on the activation handle 80 along a directional arrow 86 shown in FIG. 7 pulls the activation tab 82 away from the front panel 76, and begins to rotate the pivoting eyewash head assembly 58 away from the body of the portable tank 22 by way of being connected to the activation tab 82 by a pair of activation straps 84 (FIGS. 8-11). This allows for activation of the portable tank 22, while the outer surface 26 of the portable tank 22 remains substantially enclosed by the insulation jacket 60, as shown best in FIG. 10.

Although several embodiments have been described in detail for purposes of illustration, various modifications may be made without departing from the scope and spirit of the invention. Accordingly, the invention is not to be limited, except as by the appended claims.

What is claimed is:

1. A tempered portable wash unit, comprising:
a container having an interior for selectively receiving and retaining a select quantity of fluid;
a dispenser coupled with the container and in fluid communication with the fluid retaining interior, the dispenser actuable between a first closed position restricting outflow of fluid from the container and a second open position permitting dispensing fluid from the container; and
a heat trace cable coupled with the container and positioned therewith for generating variable heat along its length thereof in response to changes in localized temperatures to generally maintain the temperature of the fluid within the container within a desired threshold temperature.

2. The tempered portable wash unit of claim 1, wherein the heat trace cable is generally equidistantly disposed about the container and operable to maintain fluid therein at the desired threshold temperature in an ambient atmospheric temperature as low as −30° Fahrenheit (“F”).

3. The tempered portable wash unit of claim 1, wherein the container, the dispenser, and the heat trace cable are compliant with an ANSI Class 1 Div. 1 classification.

4. The tempered portable wash unit of claim 1, wherein the desired threshold temperature comprises a range of 60° F. to 100° F.

5. The tempered portable wash unit of claim 1, wherein the heat trace cable comprises a self-regulating temperature material.

6. The tempered portable wash unit of claim 5, wherein the self-regulating temperature material decreases electrical resistance with decreased temperature along a first length thereof, thereby variably increasing heat along the first length, while simultaneously increasing electrical resistance with increased temperature along a second length thereof, thereby variably decreasing heat along the second length.

7. The tempered portable wash unit of claim 1, including a current restrictor inline with the heat trace cable and responsive to temperature changes, the current restrictor increasing current in response to decreased temperature and decreasing current in response to increased temperature.

8. The tempered portable wash unit of claim 1, wherein the heat trace cable includes a semi-conductive polymer restricting heat generation to below a pre-determined threshold temperature.

9. The tempered portable wash unit of claim 1, including a temperature probe positioned within the interior of the container for taking periodic or real-time temperature readings of fluid therein.

10. The tempered portable wash unit of claim 9, including a controller for activating and/or deactivating the heat trace cable in response to temperature readings from the temperature probe.

11. The tempered portable wash unit of claim 10, including an over-temp thermostat for monitoring an ambient air temperature, the controller turning off power to the heat trace cable when the ambient air temperature exceeds a predetermined temperature.

12. The tempered portable wash unit of claim 1, including an insulative covering at least partially disposed over at least a portion of the heat trace cable to generally deflect heat from the heat trace cable toward the interior of the container.

13. The tempered portable wash unit of claim 12, wherein the insulative covering comprises a foil tape.

14. The tempered portable wash unit of claim 13, wherein the heat trace cable comprises a rectangular cross-section and is flush mounted to an exterior of the container.

15. The tempered portable wash unit of claim 1, including an insulation jacket surrounding the container and the heat trace cable.

16. The tempered portable wash unit of claim 1, wherein the container, the dispenser, and the heat trace cable are rated for deployment in sub-zero and explosive environments.

17. A tempered portable wash unit retrofit system, comprising:
a generally flexible jacket having a size and shape for selectively surrounding a container having a chamber for selectively receiving and retaining a select quantity of fluid; and
a heat trace cable generally lining an interior of the flexible jacket, the heat trace cable being disposed in adjacent relation to an exterior of the container when the flexible jacket is wrapped about the container, the heat trace cable generating variable heat along its length thereof in response to changes in localized temperatures to generally maintain the temperature of the fluid within the container within a desired threshold temperature.

18. The system of claim 17, wherein the heat trace cable is disposed at approximate equidistant intervals along the interior of the flexible jacket and operable to maintain fluid within the container at the desired threshold temperature in an ambient atmospheric temperature as low as −30° Fahrenheit (“F”).

19. The system of claim 18, wherein generally parallel sections of the heat trace cable are offset by one another by approximately 1-3 inches and the heat trace cable is offset from an outer and an inner periphery of the flexible jacket by approximately 1-3 inches.

20. The system of claim 18, wherein the desired threshold temperature comprises between 60° F. and 100° F.

21. The system of claim 17, wherein the flexible jacket includes a foil liner for deflecting heat generation toward the container.

22. The system of claim 17, wherein the flexible jacket includes an insulation layer.

23. The system of claim 17, including a dispenser pocket configured to generally align with a dispenser of the container, the dispenser pocket being actuable between a first closed position positioning the dispenser in a flow restricting position, and a second open position moving the dispenser to a second flow permitting position.

24. The system of claim 17, wherein the flexible jacket, the container, the dispenser, and the heat trace cable are rated for deployment in sub-zero and explosive environments and are compliant with a Class 1 Div. 1 classification.

25. The system of claim 17, wherein the heat trace cable comprises a self-regulating temperature material that decreases electrical resistance with decreased temperature along a first length thereof, thereby variably increasing heat along the first length, while simultaneously increasing electrical resistance with increased temperature along a second length thereof, thereby variably decreasing heat along the second length.

26. The system of claim 17, wherein the heat trace cable comprises a rectangular cross-section and is flush mounted to the interior of the flexible jacket.

27. A tempered portable wash unit, comprising:
a container having an interior for selectively receiving and retaining a select quantity of fluid;
a dispenser coupled with the container and in fluid communication with the fluid retaining interior, the dispenser actuable between a first closed position restricting outflow of fluid from the container and a second open position permitting dispensing fluid from the container; and
a heat trace cable coupled with the container and positioned therewith for generating variable heat along its length thereof in response to changes in localized temperatures to generally maintain the temperature of the fluid within the container within a desired threshold temperature comprising a range of 60° F. to 100° F. when the tempered portable wash unit is in an environment having ambient atmospheric temperatures as low as −30° Fahrenheit (“F”), all in compliance with an ANSI Class 1 Div. 1 classification.

28. The tempered portable wash unit of claim 27, including a temperature probe positioned within the interior of the container for taking periodic or real-time fluid temperature readings, wherein the heat trace cable includes a current restrictor comprising a semi-conductive polymer restricting heat generation to below a pre-determined threshold temperature.

29. The tempered portable wash unit of claim 28, including a controller for activating and/or deactivating the heat trace cable in response to fluid temperature readings from the temperature probe or ambient air temperature readings from an over-temp thermostat, the controller restricting power to the heat trace cable when the fluid temperature or the ambient air temperature exceed a respective predetermined temperature.

30. The tempered portable wash unit of claim 27, including an insulative covering comprising a foil tape at least partially disposed over at least a portion of the heat trace cable to generally deflect heat from the heat trace cable toward the interior of the container.

31. The tempered portable wash unit of claim 27, wherein the heat trace cable comprises a rectangular cross-section and is flush mounted to an exterior of the container and sandwiched in between the exterior of the container and an insulation jacket surrounding the container, wherein the container, the dispenser, the heat trace cable, and the jacket are rated for deployment in sub-zero and explosive environments.

32. The tempered portable wash unit of claim 27, wherein the heat trace cable comprises a self-regulating temperature material generally equidistantly disposed about the container, the self-regulating temperature material decreases electrical resistance with decreased temperature along a first length thereof, thereby variably increasing heat along the first length, while simultaneously increasing electrical resistance with increased temperature along a second length thereof, thereby variably decreasing heat along the second length.
